(19) United States
(12) Patent Application Publication
(10) Pub. No.: US 2023/0059496 A1
(43) Pub. Date: Feb. 23, 2023

(54) GENERATING DISRUPTIVE PATTERN MATERIALS

(71) Applicant: Noodle Technology Inc., San Francisco, CA (US)

(72) Inventors: Garrett Edward Kinsman, San Francisco, CA (US); Micha Anthenor Benoliel, San Francisco, CA (US)

(21) Appl. No.: 17/820,547

(22) Filed: Aug. 17, 2022

Related U.S. Application Data
(60) Provisional application No. 63/234,178, filed on Aug. 17, 2021.

(51) Int. Cl. G06N 3/12; F41H 3/02

(52) U.S. Cl. CPC G06N 3/126; F41H 3/02

(57) ABSTRACT

A method for training a machine learning model includes obtaining camouflage material data. The method includes obtaining environmental data. The method also includes generating the machine learning model based on the camouflage material data and the environmental data. The method includes generating a plurality of camouflage patterns based on the machine learning model. The method includes assigning a rank to each of the camouflage patterns. The method further includes training the machine learning model with a camouflage pattern assigned with a highest rank.

### CROSS REFERENCE TO RELATED APPLICATIONS

This U.S. patent application claims priority to U.S. Provisional Patent Application 63/234,178 filed on Aug. 17, 2021. The disclosure of this prior application is considered part of the disclosure of this application and is hereby incorporated by reference in its entirety.

### TECHNICAL FIELD

This disclosure relates to generating camouflage patterns or images (that are disruptive and/or concealing) and implementing the camouflage patterns or images.

### BACKGROUND

Many camouflage patterns in active use today are over a decade old. Often the camouflages are non-moving patterns that are intended to conceal an object (e.g., soldier, combat vehicle) from the enemies by blending in the object with surrounding environments.

The subject matter claimed in the present disclosure is not limited to implementations that solve any disadvantages or that operate only in environments such as those described above. Rather, this background is only provided to illustrate one example technology area where some embodiments described in the present disclosure may be practiced.

### SUMMARY

One aspect of the disclosure provides a method for training a machine learning model. The method includes obtaining, at data processing hardware, camouflage material data. The method includes obtaining, at the data processing hardware, environmental data. The method also includes generating, by the data processing hardware, the machine learning model based on the camouflage material data and the environmental data. The method includes generating, by the data processing hardware, a plurality of camouflage patterns based on the machine learning model. The method further includes assigning, by the data processing hardware, a rank to each of the camouflage patterns. The method includes training, by the data processing hardware, the machine learning model with a camouflage pattern assigned with a highest rank.

Another aspect of the disclosure provides a system for training a machine learning model. The system includes data processing hardware and memory hardware in communication with the data processing hardware. The memory hardware stores instructions that when executed on the data processing hardware cause the data processing hardware to perform operations. The operations include obtaining camouflage material data. The operations include obtaining environmental data. The operations also include generating the machine learning model based on the camouflage material data and the environmental data. The operations includes generating a plurality of camouflage patterns based on the machine learning model. The operations further include assigning a rank to each of the camouflage patterns. The operations include training the machine learning model with a camouflage pattern assigned with a highest rank.

Another aspect of the disclosure provides a method for training a machine learning model. The method includes obtaining, at data processing hardware, one or more of camouflage material parameters. The method also includes obtaining, at the data processing hardware, environmental data. The method includes generating, by the data processing hardware, a plurality of camouflage patterns based on the one or more of the camouflage material parameters and the environmental data.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a system for training a model for generating camouflage patterns.

FIG. 2 is a schematic view illustrating a method for ranking each of the camouflage patterns.

FIG. 3 is a flowchart of an example arrangement of operations for a method for training the machine learning model for generating camouflage materials in accordance with some implementations.

FIG. 4 is a flowchart of an example arrangement of operations for a method for generating a camouflage pattern that is suitable to use with respect to the environment.

FIG. 5A is a simplified perspective view of a camouflage system configured to hide or conceal a stationary subject.

FIG. 5B is a simplified top-down view of the camouflage system configured to hide or conceal the stationary subject.

FIG. 6 is a side view of a truck implemented with a camouflage system.

FIG. 7A is a top down view of a blanket implemented with the camouflage system in accordance with some implementations.

FIG. 7B is a cross-sectional view taken along line I-I′ of FIG. 7A.

FIG. 8 is a schematic view illustrating a machine in the example form of a computing device.

Like reference symbols in the various drawings indicate like elements.

### DETAILED DESCRIPTION

Implementations herein are directed toward techniques to generate and implement camouflages (e.g., moving camouflage images, non-moving camouflage images, moving camouflage patterns, non-moving camouflage patterns) (also referred as camouflage materials) that are disruptive and/or concealing. In some implementations, the techniques includes utilizing computer vision and neural network (e.g., deep neural network (DNN), convolution neural network (CNN)) based genetic models. Techniques described herein may be used for developing and implementing camouflage materials that can combat new computer vision systems.

In some implementations, the camouflage materials may be generated by starting with a set of camouflage pattern material parameters (e.g., unit designation, artistic designs, colors) (also referred as camouflage pattern material data) and combining the camouflage pattern material parameters with environmental input (e.g., photos of the surrounding area) (also referred as environmental data) to create a pattern model (also referred as machine learning model). In some implementations, this pattern model is then used to generate a number of camouflage patterns. Each of the camouflage patterns is then tested with respect to the environment. In some implementations, the best results are chosen, and used as input data (e.g., input parameters) for training the pattern model for better results. This may be used to generate camouflage patterns for use in operational environments, for one time mission use, or applied in real time to generate active, adaptive camouflage materials.

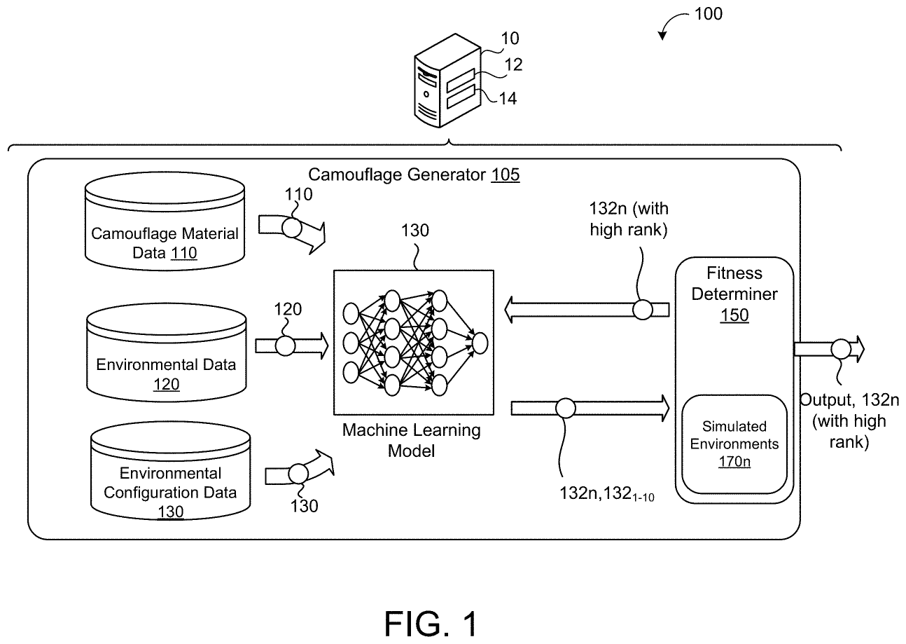

Referring to FIG. 1, in some implementations, an example system 100 includes a processing system 10 (also referred as computing device). The processing system 10 may be a single computer, multiple computers, or a distributed system (e.g., a cloud environment) having fixed or scalable/elastic computing resources 12 (e.g., data processing hardware) and/or storage resources 14 (e.g., memory hardware). The processing system 10 executes a camouflage generator 105.

In some implementations, the camouflage generator 105 includes a machine learning model 130 (e.g., neural network based model) which is configured based on input data (e.g., camouflage material data 110, environmental data 120, environmental configuration data 125).

In some implementations, the camouflage material data 110 includes a set of different combinations of parameters. In some implementations, each of the combinations of parameters includes at least one parameter for color. In some implementations, each of the combinations of parameters includes at least one parameter for artistic pattern. In some implementations, each of the combinations of parameters includes at least one parameter for locations (e.g., intended use locations). In some implementations, each of the combinations of parameters includes at least one parameter for limiting factor (e.g., limitation factor that limits other parameters). In some implementations, the camouflage material data 110 (e.g., set of different combinations of parameters) is stored at the storage resource 14 or other suitable storage.

In some implementations, the camouflage material data 110 includes parameters for colors. For example, the camouflage material data 110 includes parameters for each color combination (e.g., parameter for each combination of color (hue), color intensity (chroma), and/or brightness) that can be used to generate the camouflage materials 132. In some implementations, the use of the parameter for color is limited by the parameter for the limitation factor. For example, based on the limitation factor parameter, only certain color parameters can be used by the camouflage generator 105. This can be helpful to maintain the identification across the units or to maintain certain artistic appearances. In some implementations, based on the limitation factor parameter, certain color parameters cannot be used by the camouflage generator 105 for the similar reasons.

In some implementations, the camouflage material data 110 includes parameters for artistic patterns. For example, the camouflage material data 110 includes parameters for each visual repetitive elements (e.g., symmetry patterns, spiral patterns, wave patterns, foam patterns, tile patterns, stripe patterns) that can be used to generate the camouflage materials 132. In some implementations, the use of the parameter for artistic pattern is limited by the parameter for the limitation factor. For example, based on the limitation factor parameter, only certain pattern parameters can be used by the camouflage generator 105. This can be helpful to maintain the identification across the units or to maintain certain artistic appearances. In some implementations, based on the limitation factor parameter, certain pattern parameters cannot be used by the camouflage generator 105 for the similar reasons.

In some implementations, the camouflage material data 110 includes parameters for locations (e.g., intended to use locations). For example, the camouflage material data 110 includes parameters for each environmental setting (e.g., jungle environment, urban environment, desert environment, ocean environment) that can be used to generate the camouflage materials 132. In some implementations, the use of the parameter for location is limited by the parameter for the limitation factor. For example, based on the limitation factor parameter, only certain location parameters can be used by the camouflage generator 105. This can be helpful to maintain the identification across the units or to maintain certain artistic appearances. In some implementations, based on the limitation factor parameter, certain location parameters cannot be used by the camouflage generator 105 for the similar reasons.

In some implementations, the camouflage generator 105 obtains the camouflage material data 110. In some implementations, the camouflage generator 105 obtains a set of different combinations of parameters that are pre-determined. In some implementations, the camouflage generator 105 obtains a set of different combinations of parameters that are randomly generated based on various parameters discussed above. Based on the received camouflage material data 110, in some implementations, the camouflage generator 105 generates the machine learning model 130. As will be described in more details below, in some implementations, the machine learning model 130, which is created based the camouflage material data 110, is updated based on a suitable algorithm (e.g., genetic algorithm).

In some implementations, the camouflage generator 105 obtains environmental data 120. In some implementations, the environmental data 120 includes data obtained from various sensors (e.g., camera, temperature sensor, global positioning sensor, clock, light sensor, air quality sensor). In some implementations, the environmental data 120 includes pre-configured information (e.g., pre-determined color intensity for the camouflage materials 132 to be generated by machine learning model 130). In some implementations, the camouflage generator 105 obtains the environmental data 120 in real time for a continuous generation of camouflage materials 132.

In some implementations, the environmental data 120 includes terrain information (e.g., images, satellite images, images taken from aircraft/drone, street view images taken from (autonomous) vehicle). In some implementations, the environmental data 120 includes live image information obtained from one or more sensors (e.g., optical images, electromagnetic images, multispectral images, thermal images). In some implementations, the environmental data 120 includes electromagnetic background radiation information. In some implementations, the environmental data 120 includes noise information (e.g., ambient sound/noise information). In some implementations, the environmental data 120 includes air temperature information. In some implementations, the environmental data 120 includes weather information. In some implementations, the environmental data 120 includes luminosity information. In some implementations, the environmental data 120 includes light source information. In some implementations, the environmental data 120 includes reflected light information. In some implementations, the environmental data 120 includes direction information of light source. In some implementations, the environmental data 120 includes time information. In some implementations, the environmental data 120 includes geolocation information. In some implementations, the camouflage generator 105 is configured to determine the position of sun based on the time information and the geolocation information.

In some implementations, the machine learning model 130 generates camouflage materials 132 (e.g., camouflage patterns 132n) that are more relevant to the current environment based on the environmental data 120. In some implementations, based on the data received from the camouflage material data 110 and the environmental data 120, the camouflage generator 105 creates (or updates) the machine learning model 130 so that the machine learning model 130 is able to generate more relevant camouflage materials 132 with respect to the current environment.

In some implementations, the camouflage generator 105 obtains environmental configuration data 125 (e.g., environmental data from one or more observers, environmental configuration data). In some implementations, the environmental configuration data 125 includes three-dimensional model information of the subject that needs to be concealed and/or three-dimensional model information of environment the subject is intended to be located at. In some implementations, the environmental configuration data 125 includes datums and external reference information (geomagnetic north, for example, inertial guidance). In some implementations, the environmental configuration data 125 includes expected maneuver information of the subject (e.g., vehicle). In some implementations, the expected maneuver information is generated by the accelerometer in the vehicle. In some implementations, the expected maneuver information is generated by input of the vehicle (e.g., left-turn and right-turn signals from fly-by-wire system in the vehicle). In some implementations, the environmental configuration data 125 includes intention of operation information (e.g., night operation, scare operation, fast movement operation). In some implementations, the environmental configuration data 125 includes limits on design (e.g., limitation on scale and/or color to maintain cross unit identification).

In some implementations, the machine learning model 130 generates camouflage materials 132 (e.g., camouflage patterns 132n) that are more relevant to the current environment based on the environmental configuration data 125. In some implementations, based on the data received from the camouflage material data 110 and the environmental configuration data 125, the camouflage generator 105 creates (or updates) the machine learning model 130 so that the machine learning model 130 is able to generate more relevant camouflage materials 132 with respect to the current environment.

In some implementations, the machine learning model 130 generates camouflage materials 132 that are more relevant to the current environment based on the environmental data 120 and the environmental configuration data 125. In some implementations, based on the data received from the camouflage material data 110, the environmental data 120, and the environmental configuration data 125, the camouflage generator 105 creates (or updates) the machine learning model 130 so that the machine learning model 130 is able to generate more relevant camouflage materials 132 with respect to the current environment.

In accordance with some implementations, the camouflage materials 132 (e.g., camouflage pattern 132n) can be deployed for various applications (e.g., clothing, vehicles, aircraft. buildings, equipment, spacecraft, autonomous vehicles, weapons, bases).

In some implementations, the camouflage patterns 132n is printed before missions based on latest ground conditions or for specific lighting (for example early morning vs noonday sunlight).

As shown in FIG. 1, in some implementations, the machine learning model 130 created based on the data (e.g., camouflage material data 110, environmental data 120, environmental configuration data 125) generates a number of camouflage materials 132 (ten camouflage patterns 132₁₋₁₀ in this example). For example, the first camouflage pattern 132₁ is created based on a first combination of parameters including a parameter for yellow color, a parameter for wave pattern, and a parameter for desert location, and the second camouflage pattern 132₂ is created based on a second combination of parameters including a parameter for khaki color, a parameter for circular pattern, and a parameter for jungle location, and the third pattern 132₃ is created based on a third combination of parameters including a parameter for green color, a parameter for oval pattern, and a parameter for ocean location. Similarly, each of the rest of camouflage patterns 132₄₋₁₀ is based on a different combination of parameters.

In some implementations, the machine learning model 130 generates at least one mutated camouflage patterns 132n by randomly changing one or more parameters of other camouflage patterns 132n. In some implementations, the machine learning model 130 generates “crossover” camouflage patterns 132n (e.g., two camouflage patterns 132n swapping one or more parameters). In some implementations, the machine learning model 130 adds noise (e.g., noise parameter, random noise parameter) to one or more camouflage patterns 132n to generate diverse camouflage patterns 132n.

In some implementations, the machine learning model 130 generates the camouflage materials 132 (camouflage patterns 132₁₋₁₀ in this example) based on random combinations of the data (e.g., parameters) obtained from the camouflage material data 110, environmental data 120, and/or environmental configuration data 125. In some implementations, the machine learning model 130 generates the camouflage materials 132 using a genetic algorithm (e.g., “mutation,” “crossover,” “noise”) based on the data (e.g., camouflage material data 110, environmental data 120, environmental configuration data 125). As shown in FIG. 1, in some implementations, the machine learning model 130 generates (or transmits) ten camouflage patterns 132₁₋₁₀ to a camouflage material tester 150 so that the camouflage material tester 150 can compare the ten camouflage patterns 132₁₋₁₀ to each other. However, this disclosure does not limit the number of the camouflage patterns 132n generated at the machine learning model 130 to the ten camouflage patterns 132n. For example, the machine learning model 130 generates more than ten camouflage patterns 132n or less than ten camouflage patterns 132n. Accordingly, the camouflage tester 150 is configured to compare more than ten camouflage patterns 132n to each other or less than ten camouflage patterns 132n to each other.

As shown, in some implementations, the camouflage material tester 150 compares each of the camouflage patterns 132₁₋₁₀ generated by the machine learning model 130 with the respective environment where the camouflage patterns 132₁₋₁₀ are intended to be used. In some implementations, the camouflage material tester 150 determines how well each of the camouflage patterns 132₁₋₁₀ blends in with the respective environment (e.g., background). In some implementations, the camouflage material tester 150 ranks each of camouflage patterns 132₁₋₁₀ based on the comparison.

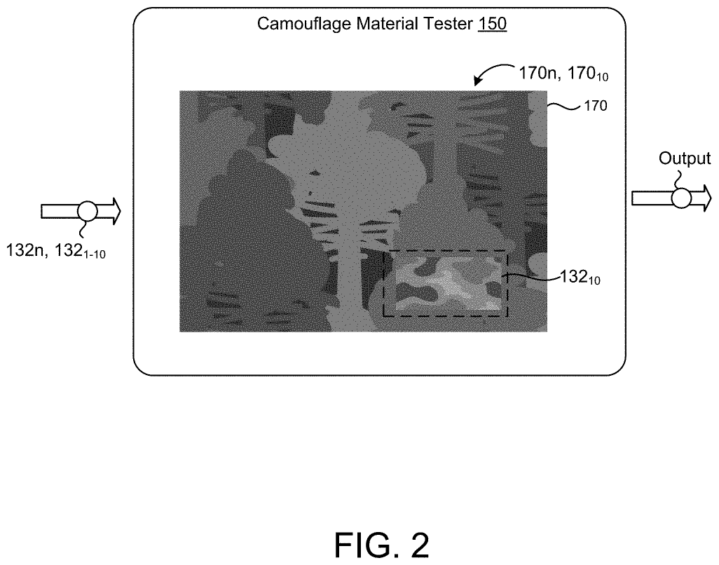

Referring to FIG. 2, in some implementations, the camouflage generator 150 includes the camouflage material tester 150 which is configured to determine how well each of the camouflage patterns 132n blends in with the respective environment 170 where the camouflage patterns 132n are intended to be used.

As shown, in some implementations, the camouflage material tester 150 generates simulated environments 170n. Each of the simulated environments 170n includes corresponding camouflage patterns 132n and the environment 170 based on the data (e.g., environmental data 120, environmental configuration data 125).

As illustrated in FIG. 2, to generate the simulated environments 170n, in some implementations, a corresponding camouflage patterns 132n, from the machine learning model 130, is placed onto (e.g., overlaid on, positioned into) the environment 170. As shown, in some implementations, the shape of the camouflage pattern 132n is a rectangular shape, and the camouflage pattern 132n is at a random location of the environment 170. However, this disclosure does not limit the shape of the camouflage pattern 132n and the overlay location for this camouflage material detection test. For example, the shape of the camouflage pattern 132n can be any suitable shape (e.g., circle, triangle, square, hexogen, octagon, pentagon, oval, rectangle, rhombus, star). In some implementations, the overlay location is a random location. In some implementations, the overlay location is a predetermined location.

In some implementations, this testing process uses computer vision through the simulated environments, or more complex systems such as a deep learning neural network based system.

As discussed above, in some implementations, the camouflage material tester 150 determines or measures how well each of the camouflage patterns 132n from the machine learning model 130 blends in with the environment 170 using the computer vision or the neural network based system.

In some implementations, the camouflage material tester 150 determines how well the camouflage pattern 132n blends in with the environment 170 based on the simulated environment 170n. In some implementations, the camouflage material tester 150 determines whether the computer vision system (and/or the neural network based system) is able to detect the camouflage pattern 132n in the simulated environment 170n. In some implementations, the camouflage material tester 150 determines whether the computer vision system (and/or the neural network based system) is able to detect the camouflage pattern 132n in the simulated environment 170n within a predetermined time. In some implementations, the camouflage material tester 150 determines how long does the computer vision (and/or the neural network system) takes to detect the camouflage pattern 132n in the simulated environment 170n.

In some implementations, the camouflage material tester 150 ranks each of the camouflage patterns 132n based on the results from the camouflage material detection test. In some implementations, the camouflage pattern 132n that is not detected by the computer vision system (and/or the neural network based system) ranks higher than the camouflage pattern 132n that is detected by the computer vision system (and/or the neural network based system). In some implementations, a camouflage pattern 132n that takes longer time to detect by the computer vision system (and/or the neural network based system) is ranked higher than a camouflage pattern 132n that takes less time to detect by the computer vision system (and/or the neural network based system).

In some implementations, based on the results from the camouflage material detection test, one or more of camouflage patterns 132 with a lower rank is deleted from the system 100.

In some implementations, based on the results from the camouflage material detection test, one or more of camouflage patterns 132 with a higher rank is output as a camouflage patterns Output to be used (e.g., camouflage pattern 132n which was not detected in the camouflage material detection test, camouflage pattern 132n which was not detected in the camouflage material detection test within a predetermined time, camouflage pattern 132n with a high rank).

In some implementations, based on the results from the camouflage material detection test, one or more of camouflage patterns 132n with a higher rank is transmitted back to the machine learning model 130 for training the machine learning model 130 (e.g., camouflage pattern 132n which was not detected in the camouflage material detection test, camouflage pattern 132n which was not detected in the camouflage material detection test within a predetermined time, camouflage pattern 132n with a high rank). In some implementations, “crossover” is performed to the camouflage patterns 132n before transmitting back to the machine learning model 130 (e.g., two camouflage patterns 132n swapping one or more parameters). In some implementations, mutation is performed to the camouflage patterns 132n before transmitting back to the machine learning model 130 (e.g., making random change to one or more parameters in the camouflage pattern 132n). In some implementations, noise (e.g., noise parameter, random noise parameter) is added to the camouflage patterns 132n before transmitting back to the machine learning model 130.

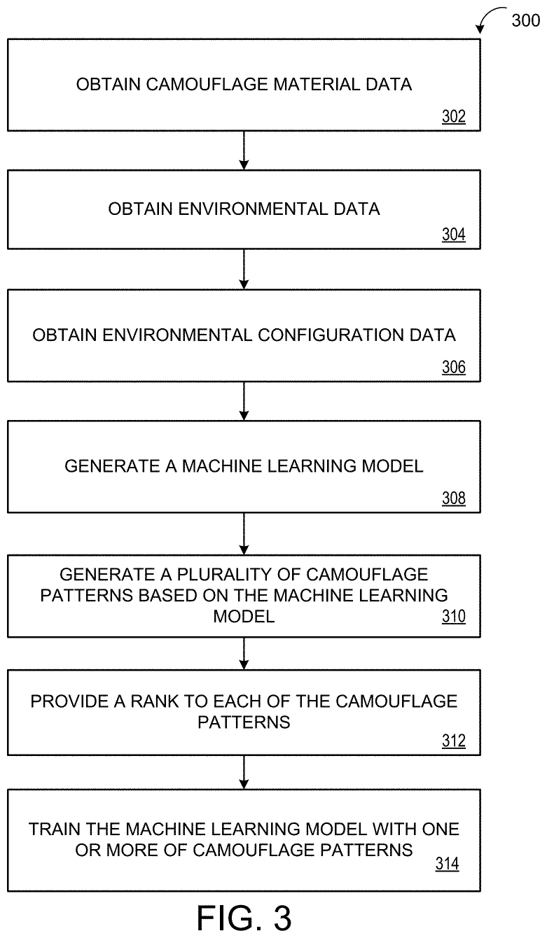

FIG. 3 is a flowchart of an example arrangement of operations for a method 300 for training the machine learning model 130 for generating camouflage materials 132 (e.g., camouflage pattern 132n) in accordance with some implementations. The method 300 may be performed by processing logic that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 300, at operation 302, includes obtaining, at the data processing hardware 12, the camouflage material data 110. As discussed above, in some implementations, the camouflage material data 110 includes color parameters, artistic pattern parameters, location parameters, and/or limiting factor parameters.

At operation 304, the method 300 includes, obtaining, at the data processing hardware 12, the environmental data 120. As discussed above, in some implementations, the environmental data 120 includes data obtained from various sensors (e.g., camera, temperature sensor, global positioning sensor, clock, light sensor, air quality sensor). In some implementations, the environmental data 120 includes pre-configured information (e.g., pre-determined color intensity for the camouflage materials to be generated by machine learning model 130). In some implementations, the camouflage generator 105 obtains the environmental data 120 in real time for a continuous generation of camouflage materials.

At operation 306, the method 300 includes, obtaining, at the data processing hardware 12, the environmental configuration data 125. As discussed, in some implementations, the environmental configuration data 125 includes three-dimensional model information of the subject that needs to be concealed and/or three-dimensional model information of environment the subject is intended to be located at. In some implementations, the environmental configuration data 125 includes datums and external reference information (geomagnetic north, for example, inertial guidance). In some implementations, the environmental configuration data 125 includes expected maneuver information of the subject (e.g., vehicle). In some implementations, the expected maneuver information is generated by the accelerometer in the vehicle. In some implementations, the expected maneuver information is generated by input of the vehicle (e.g., left-turn and right-turn signals from fly-by-wire system in the vehicle). In some implementations, the environmental configuration data 125 includes intention of operation information (e.g., night operation, scare operation, fast movement operation). In some implementations, the environmental configuration data 125 includes limits on design (e.g., limitation on scale and/or color to maintain cross unit identification).

At operation 308, the method 300 includes, generating, by the data processing hardware 12, the machine learning model 130 based on the obtained data (e.g., camouflage material data 110, environmental data 120, environmental configuration data 125).

At operation 310, the method 300 includes, generating, by the data processing hardware 12, a plurality of camouflage patterns 132n based on the machine learning model 150. As discussed above, in some implementations, the plurality of camouflage patterns 132n includes one or more mutated camouflage patterns 132n. In some implementations, the plurality of camouflage patterns 132n may include “crossover” camouflage patterns 132n (e.g., parameter swapping).

At operation 312, the method 300 includes, determining, by the data processing hardware 12, whether each of the camouflage patterns 132n is suitable to use in the intended environment 170. As discussed above, in some implementations, the camouflage detection test is performed on each of the camouflage patterns 132n. Based on the test result, each of the camouflage patterns 132n is ranked.

At operation 314, the method 300 includes, training, by the data processing hardware 12, the machine learning model 130 with one or more camouflage patterns 132n having a higher rank. As discussed, in some implementations, the one or more camouflage patterns 132n having a higher rank includes at least one mutated camouflage pattern 132n. In some implementations, the one or more camouflage patterns 132n having a higher rank includes at least some “crossover” camouflage pattern 132n. In some implementations, the one or more camouflage patterns 132n having a higher rank includes noise added prior to transmitting to the machine learning model 130.

In some implementations, the operations 302-312 are repeated for training the machine learning model 130.

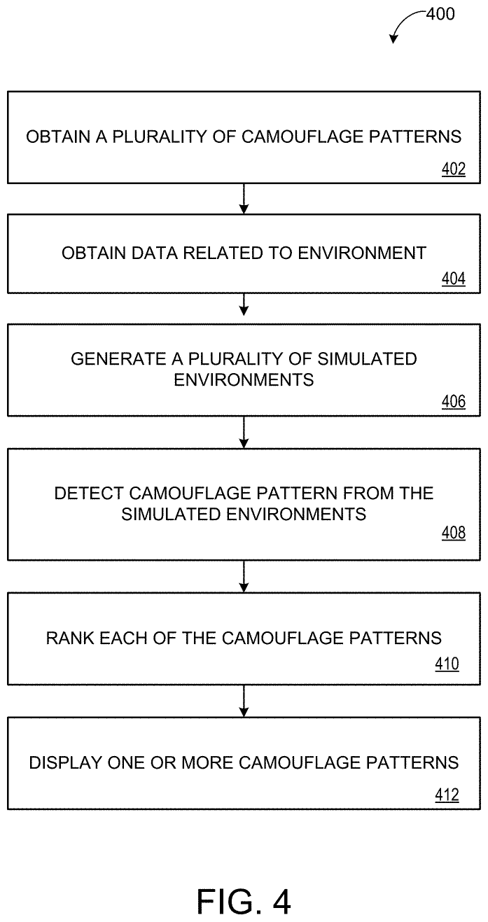

FIG. 4 is a flowchart of an example arrangement of operations for a method 400 for generating a camouflage pattern 132n that is suitable to use with respect to the environment 170. The method 400 may be performed by processing logic that may include hardware (circuitry, dedicated logic, etc.), software (such as is run on a general purpose computer system or a dedicated machine), or a combination of both, which processing logic may be included in any computer system or device. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 400, at operation 402, includes obtaining, at the data processing hardware 12, a plurality of the camouflage patterns 132n (e.g., camouflage patterns 132₁₋₁₀ in FIG. 2) from the machine learning model 130. As discussed above, in some implementations, the machine learning model 130 transmits a number of camouflage patterns 132n to the camouflage material tester 150.

At operation 404, the method 400 includes, obtaining, by the data processing hardware 12, data related to the environment 170 (e.g., environmental data 120, environmental configuration data 125). As discussed above, in some implementations, the environmental data 120 includes data obtained from various sensors (e.g., camera, temperature sensor, global positioning sensor, clock, light sensor, air quality sensor). In some implementations, the environmental data 120 includes pre-configured information (e.g., pre-determined color intensity for the camouflage materials to be generated by machine learning model 130). In some implementations, the camouflage generator 105 obtains the environmental data 120 in real time for a continuous generation of camouflage materials.

At operation 406, the method 400 includes, generating, by the data processing hardware 12, a plurality of simulated environments 170n. Each of the simulated environment 170n includes a corresponding camouflage pattern 132n and the environment 170 (e.g., photo). As discussed above, to generate the simulated environments 170n, in some implementations, a corresponding camouflage patterns 132n, from the machine learning model 130, is placed onto (e.g., overlaid on, positioned into) the environment 170.

At operation 408, the method 400 includes, by the data processing hardware 12, detecting camouflage pattern 132n from the corresponding simulated environments 170n. As discussed above, in some implementations, the camouflage material tester 150 determines how well each of the camouflage patterns 132n blends in with the environment 170 based on the simulated environment 170n. In some implementations, the camouflage material tester 150 determines whether the computer vision system (and/or the neural network based system) is able to detect the camouflage pattern 132n in the simulated environment 170n. In some implementations, the camouflage material tester 150 determines whether the computer vision system (and/or the neural network based system) is able to detect the camouflage pattern 132n in the simulated environment 170n within a predetermined time. In some implementations, the camouflage material tester 150 determines how long does the computer vision (and/or the neural network system) takes to detect the camouflage pattern 132n in the simulated environment 170n.

At operation 410, the method 400 includes, by the data processing hardware 12, ranking each of the camouflage patterns 132n based on the results from the camouflage material detection test. In some implementations, the camouflage pattern 132n that is not detected by the computer vision system (and/or the neural network based system) ranks higher than the camouflage pattern 132n that is detected by the computer vision system (and/or the neural network based system). In some implementations, a camouflage pattern 132n that takes longer time to detect by the computer vision system (and/or the neural network based system) is ranked higher than a camouflage pattern 132n that takes less time to detect by the computer vision system (and/or the neural network based system).

At operation 412, the method 400 includes, by the data processing hardware 12, displaying one or more camouflage patterns 132n based on the ranking result. As discussed, camouflage patterns 132n having a higher rank are selected to be used in the intended environment 170.

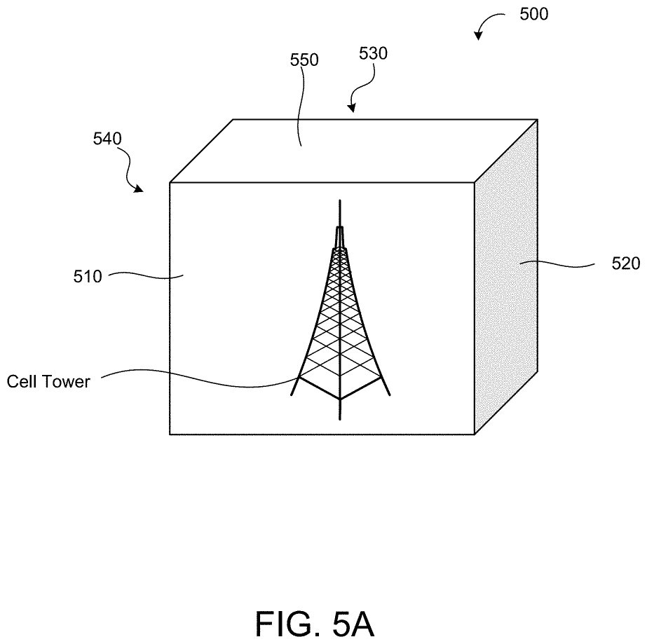

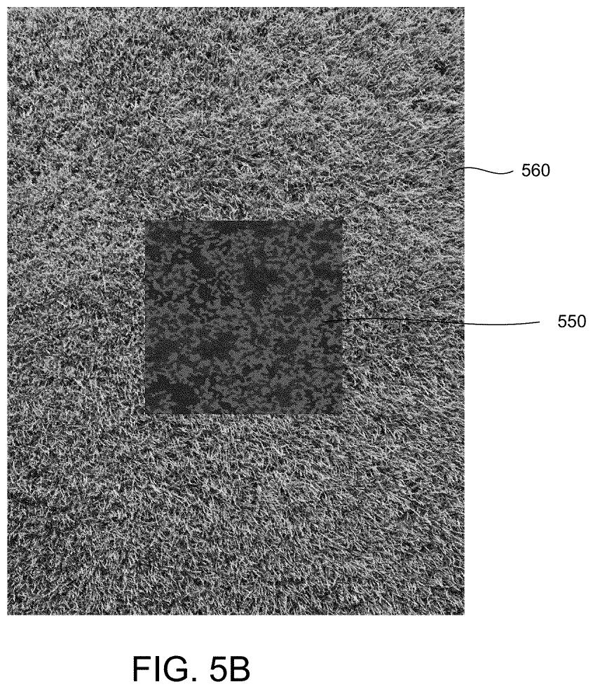

FIG. 5A is a simplified perspective view of a camouflage system 500 configured to hide or conceal a stationary subject (cellular tower in this example).

As illustrated in FIG. 5A, in some implementations, the camouflage system 500 includes a cover 502 including a plurality of rectangular shape displays 510-550 configured to display the camouflage materials 132 (e.g., camouflage pattern 132n) generated from the camouflage generator 105 (shown in FIGS. 1 and 2).

In some implementations, the displays 510-550 can be any suitable type of display (liquid-crystal display (LCD), organic light-emitting diode display (OLED), e-ink display, rollable display, flexible display).

As shown in FIG. 5A, the cover 502 includes four side displays 510-540 and a top side display 550. Each display 510-550 is configured to display the camouflage materials 132. In some implementations, the camouflage generator 105 is configured to generate different camouflage material 132 (e.g., camouflage pattern 132n) for each of the displays 510-550, so that each of the displays 510-550 displays the camouflage material 132 that blends in with corresponding background as shown in FIG. 5B

FIG. 5B is a simplified top-down view of the cover 502 of the camouflage system 500 configured to hide or conceal the stationary subject (cellular tower in this example).

As illustrated in FIG. 5B, the camouflage generator 105 is configured to generate camouflage material 132 (e.g., camouflage pattern 132n) that blends in well with background 560 (grass ground in this example). Accordingly, the top side display 550 displays the camouflage pattern 132n that is similar to the grass background 560 surrounding the cellular towner. This is helpful since by displaying customized camouflage material 132 with respect to corresponding background 560, the stationary subject is less like to be detected by others at different angles (e.g., enemy soldiers, enemy computer vision system). In some implementations, this implementation can be used in urban settings to hide the cellular tower or other subject for aesthetic purposes.

In some implementations, the cover 502 can be in a different shape (e.g., sphere, cube, pyramid, cylinder, cone, dome). In some implementations, the displays 510-550 also can be any suitable shape (e.g., circle, square, hexagon, octagon, pentagon, oval, rectangle, square, rhombus). In some implementations, each of the display 510-550 is connected to each other.

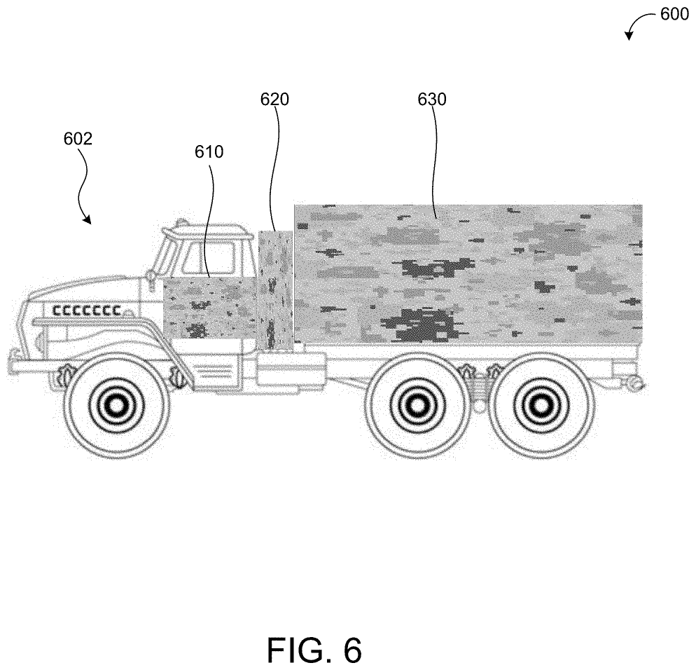

FIG. 6 is a simplified side view of a truck 602 implemented with a camouflage system 600.

As illustrated in FIG. 6, the camouflage system 600 includes a plurality of displays 610-630. As shown, in some implementations, the camouflage generator 105 is configured to generate camouflage material 132 (e.g., camouflage pattern 132n) that blends in well with background. In some implementations, each of the displays 610-630 that covers the truck 602 displays the camouflage patterns 132n from the camouflage generator 105.

In some implementations, each of the camouflage patterns for the displays 610-630 (dynamically) changes based on the movement of the truck 602. As discussed above, in some implementations, the environmental configuration data 125 includes expected maneuver information of the subject (e.g., vehicle). In some implementations, the expected maneuver information is generated by the accelerometer in the vehicle. In some implementations, the expected maneuver information is generated by input of the vehicle (e.g., left-turn and right-turn signals from fly-by-wire system in the vehicle).

Based on the environmental configuration data 125 (e.g., vehicle expected maneuver information) and environmental data 120 (e.g., geolocation), in some implementations, the camouflage generator 105 updates camouflage material 132 (e.g., camouflage pattern 132n) for each of the displays 610-630 (dynamically) while the truck 602 is moving so that the camouflage material 132 is more relevant to the changing background (e.g., surrounding).

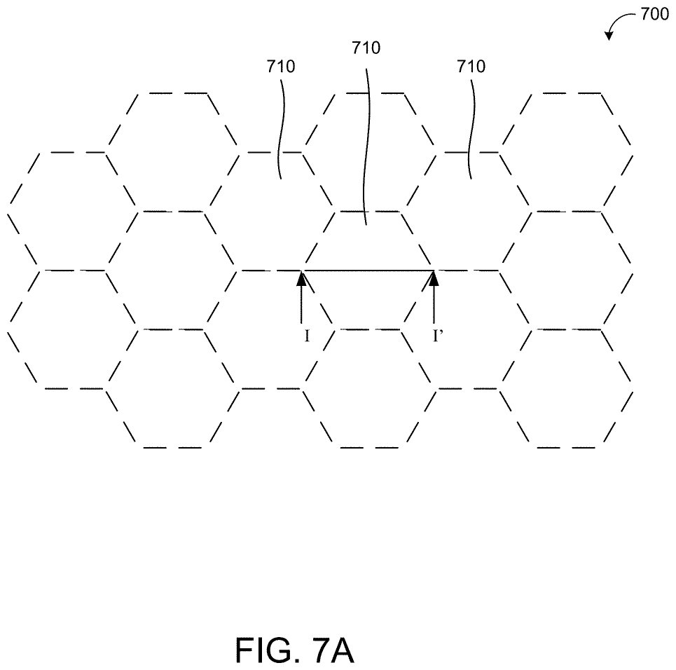

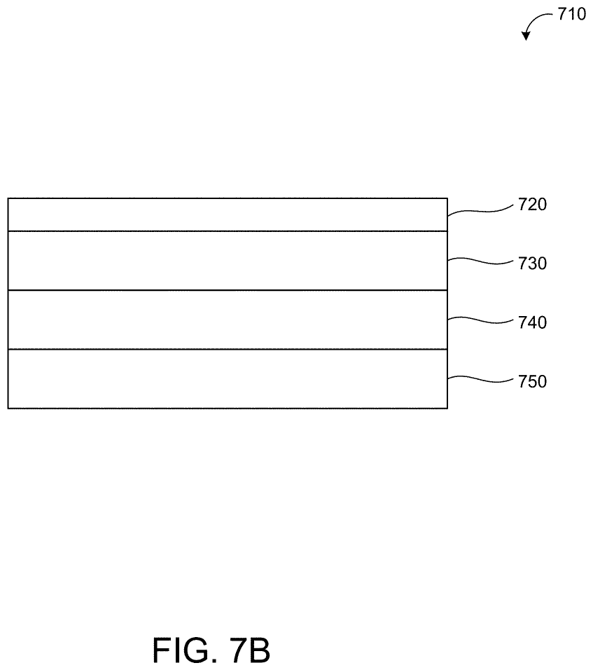

FIG. 7A is a top down view of a blanket 700 implemented with the camouflage system 700 in accordance with some implementations.

As illustrated in FIG. 7, the blanket 700 includes a plurality of modules 710. As shown, each of the modules 710 has a hexagon shape. However, this disclosure does not limit the shape of the modules 710. The modules 710 can be any suitable shape (e.g., circle, square, hexagon, octagon, pentagon, oval, rectangle, square, rhombus, oval).

In some implementation, the modules 710 communicate with each other, wired or wirelessly, to adaptively provide camouflage materials 132 (e.g., camouflage pattern 132n). For example, each of the modules 710 may obtain environmental properties (e.g., images, temperature, colors, thermal image), and may share those environmental properties with other modules 710. In some implementations, each module 710 may use one or more environmental images, for example, to determine a color (or group of colors, or disruptive pattern output) and/or thermal property to provide, such as via a color display or thermal tile. Additionally or alternatively, the array of modules 710 may collectively share processing and analysis of the environmental properties via a distributed computing architecture.

FIG. 7B is a cross-sectional view taken along line I-I′ of FIG. 7A. The module 710 includes a plurality of layers 720-750. In some implementations, the module 710 includes a display layer 720 (e.g., flexible display, transparent display), thermal layer 730 (e.g., Peltier module layer), fabric layer 740 (e.g., conductive fabric), and a water wicking layer 750. In some implementations, module 710 includes a water-proof layer (not shown in FIG. 7B).

In some implementations, the camouflage generator 105 generates camouflage materials 132 for both display layer 720 and the thermal layer 730 based on input data (e.g., environmental data 120, environmental configuration data 125).

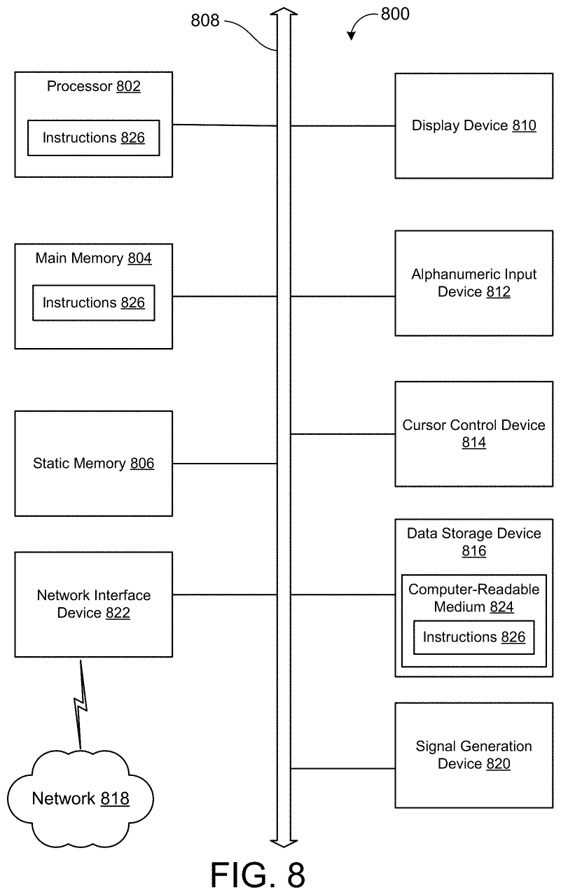

FIG. 8 is a schematic view illustrating a machine in the example form of a computing device 800 within which a set of instructions, for causing the machine to perform any one or more of the methods discussed herein, may be executed. The computing device 800 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The example computing device 800 includes a processing device (e.g., a processor) 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)) and a data storage device 816, which communicate with each other via a bus 808.

Processing device 802 represents one or more general-purpose processing devices such as a microprocessor, central processing unit, or the like. More particularly, the processing device 802 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also include one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein.

The computing device 800 may further include a network interface device 822 which may communicate with a network 818. The computing device 800 also may include a display device 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker). In at least one implementation, the display device 810, the alphanumeric input device 812, and the cursor control device 814 may be combined into a single component or device (e.g., an LCD touch screen).

The data storage device 816 may include a computer-readable storage medium 824 on which is stored one or more sets of instructions 826 embodying any one or more of the methods or functions described herein. The instructions 826 may also reside, completely or at least partially, within the main memory 804 and/or within the processing device 802 during execution thereof by the computing device 800, the main memory 804 and the processing device 802 also constituting computer-readable media. The instructions may further be transmitted or received over a network 818 via the network interface device 822.

While the computer-readable storage medium 826 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method for training a machine learning model, the method comprising:
obtaining, at data processing hardware, camouflage material data;
obtaining, at the data processing hardware, environmental data;
generating, by the data processing hardware, the machine learning model based on the camouflage material data and the environmental data;
generating, by the data processing hardware, a plurality of camouflage patterns based on the machine learning model;
assigning, by the data processing hardware, a rank to each of the camouflage patterns; and
training, by the data processing hardware, the machine learning model with a camouflage pattern assigned with a highest rank.

2. The method of claim 1, wherein the plurality of camouflage patterns includes dynamic camouflage patterns that are moving.

3. The method of claim 1, wherein the camouflage material data includes at least one of: color parameter, artistic pattern parameter, or intended use location parameter.

4. The method of claim 1, wherein the environmental data includes at least one of: terrain information, live surrounding image information, time information, geolocation information, weather information, temperature information, light information, and electromagnetic background radiation, or noise information.

5. The method of claim 4, wherein the light information includes at least one of: luminosity information, light source information, or reflected light information.

6. The method of claim 1, wherein generating the plurality of camouflage patterns based on the machine learning model includes:
generating, using a genetic algorithm, at least one camouflage pattern of the plurality of camouflage patterns.

7. The method of claim 1, further comprising:
generating, by the data processing hardware, a simulated environment for each of the camouflage patterns.

8. The method of claim 7, wherein each of the simulated environments includes a corresponding camouflage pattern on an image of environment where the corresponding camouflage pattern is intended to be used.

9. The method of claim 8, wherein the corresponding camouflage pattern is on a random location of the image of environment.

10. The method of claim 1, the method further comprising:
providing, for display, the camouflage patterns assigned with the highest rank.

11. The method of claim 1, wherein the machine learning model comprises at least one from neural network and generative adversarial network.

12. A system, comprising:
data processing hardware; and
memory hardware in communication with the data processing hardware, the memory hardware storing instructions that when executed on the data processing hardware cause the data processing hardware to perform operations comprising:
obtain camouflage material data;
obtain environmental data;
generate a machine learning model based on the camouflage material data and the environmental data;
generate a plurality of camouflage patterns based on the machine learning model;
assign a rank to each of the camouflage patterns; and
train the machine learning model with a camouflage pattern assigned with a highest rank.

13. The system of claim 12, wherein when generating the plurality of camouflage patterns based on the machine learning model, the data processing hardware is to:
generate, using a genetic algorithm, at least one camouflage pattern of the plurality of camouflage patterns.

14. The system of claim 12, the operations further comprising:
generate a simulated environment for each of the camouflage patterns.

15. The system of claim 14, wherein each of the simulated environments includes a respective camouflage pattern on an image of environment where the respective camouflage pattern is intended to be used.

16. The system of claim 15, wherein the respective camouflage pattern is on a random location of the image of environment.

17. The system of claim 12, the operations further comprising:
provide, for display, the camouflage patterns assigned with the highest rank.

18. The system of claim 12, wherein the machine learning model comprises at least one from neural network and generative adversarial network.

19. A method for generating camouflage pattern, the method comprising:
obtaining, at data processing hardware, one or more of camouflage material parameters;
obtaining, at the data processing hardware, environmental data; and
generating, by the data processing hardware, a plurality of camouflage patterns based on the one or more of the camouflage material parameters and the environmental data.

20. The method of claim 19, the method further comprising:
providing, for display, at least one of the camouflage patterns.
